(19) United States
(12) Patent Application Publication
(10) Pub. No.: US 2025/0196470 A1
(43) Pub. Date: Jun. 19, 2025

(54) LAYER COMPOSITE AND METHOD FOR THE PRODUCTION THEREOF

(71) Applicant: Thomas Hofberger GmbH, Taufkirchen (DE)

(72) Inventors: Thomas HOFBERGER, Taufkirchen (DE); Wolfgang KLAUCK, Meerbusch (DE)

(73) Assignee: Thomas Hofberger GmbH, Taufkirchen (DE)

(21) Appl. No.: 18/843,420

(22) PCT Filed: Mar. 2, 2023
(86) PCT No.: PCT/EP2023/055355

§ 371 Date: Sep. 3, 2024

(30) Foreign Application Priority Data
Mar. 4, 2022 (EP) 22160261.8

(51) Int. Cl. B32B 7/12; B32B 1/00; B32B 3/30; B32B 5/02; B32B 17/06; B32B 17/10

(52) U.S. Cl. CPC B32B 7/12; B32B 1/00; B32B 3/30; B32B 5/022; B32B 5/024; B32B 17/067; B32B 17/10036; B32B 17/10752; B32B 17/1077; B32B 17/10779; B32B 2262/0276; B32B 2262/0292; B32B 2305/72; B32B 2307/412; B32B 2307/54; B32B 2307/7376; B32B 2439/02

(57) ABSTRACT

An improved layered composite, as can be used, for example, as a multi-pane safety composite glass, and a method for the most bubble-free possible production thereof are described. The layered composite comprises a substrate, a cover layer, and a polymer layer arranged therebetween, wherein the polymer layer is bonded by means of adhesive layers to the substrate and the cover layer. The cover layer has a light transmittance according to DIN EN ISO 410 of ≥50%. The polymer layer has a tensile strength according to DIN EN ISO 527 of ≥30 MPa and the adhesive layers are layers of a cured reactive adhesive and/or radiation-curing adhesive.

The present invention relates to a layered composite, comprising a substrate, a cover layer, and a polymer layer arranged therebetween, wherein the polymer layer is bonded by means of adhesive layers to the substrate and the cover layer.

Composite safety glass made of two rigid glass layers laminated together is presently typically adhesively bonded by hot-laminatable polyvinyl butyral (PVB) or ethylene vinyl acetate copolymer (EVA) films. Thus, for example, EP 3438206 A1 describes a thermoplastic resin film and a laminate containing a glass plate. Specialized products having an ionoplast intermediate layer are sold, inter alia, under the tradename SentryGlas. It is specified that such an ionoplast intermediate layer is more durable and rigid in comparison to PVB intermediate layers.

EP 2986451 B1 discloses a method for forming a composite glass structure, the method comprising: introducing a continuous strip made of flexible glass substrate which has a thickness of not more than 0.3 mm into a non-glass substrate material, wherein the non-glass substrate material has a coefficient of thermal expansion (CTE) which is greater than that of the flexible glass substrate; laminating the flexible glass substrate onto the non-glass substrate material at an elevated temperature; and controlled cooling of the composite glass structure in order to introduce a compressive stress over a thickness of the flexible glass substrate, wherein the flexible glass substrate has a compressive strength of at least 40 MPa over the thickness of the flexible glass substrate.

US 2003/0124296 A1 relates to a thermoplastic polymer film having a turbidity of at least 4%, wherein the film is suitable in a laminate barrier for protection against the penetration of objects into the laminate with sufficient force upon impact to break glass, wherein the laminate comprises at least one glass layer and includes the following: the thermoplastic polymer film attached in a self-adhesive manner directly to the glass layer, wherein the thermoplastic polymer film essentially consists of an ionomer polymer and a UV light-absorbing material, and wherein the laminate is capable of withstanding repeated or longer loads without failure, even after fracture of the glass.

U.S. Pat. No. 5,352,528 discloses a composite pane having at least one glass pane and at least one film made of plastic containing PVC having a transparency resistant to aging and weather and energy absorption suitable for a safety pane, wherein an adhesive film is arranged between the glass pane and the plastic film, wherein the adhesive film has a stronger adhesion on the glass than on the plastic film, and wherein the adhesive film comprises a terpolymer, which comprises ethylene, either vinyl acetate or acrylic ester, and maleic acid anhydride.

DE 10 2018 124 601 A1 describes a glass construction for balustrade and/or railing glazing or glass supports having a composite element formed as a glass laminate, which consists of at least two glass panes connected by an adhesive intermediate layer made of plastic, wherein at least one edge of the composite element has an edge protector, which is connected at least in some areas to the respective end faces of the at least two glass panes of the glass laminate in such a way that the intermediate layer is protected from moisture influences. Reference is also made here to WO 2020/069983 A1.

WO 2014/086610 A1 relates to a laminate made of two rigid substrates and an adhesive film arranged therebetween, wherein at least one of the rigid substrates is transparent, wherein the thickness of the adhesive film is not greater than 80 μm and the adhesive film comprises at least one adhesive layer made of an adhesive compound to which one or more softeners are added, of which at least one softener is a reactive softener, wherein the softener proportion in the adhesive compound is a total of at least 15 wt. % and the proportion of reactive softener in the adhesive compound is at least 5 wt. %.

WO 2020/064297 A1 discloses a composite glass pane and methods for the production thereof. The composite glass pane has two glass or polycarbonate panes and at least one polymer film adhesively bonded therebetween or a film laminate and an electronic functional unit arranged therebetween. A cutout of the polymer film or the film laminate is provided in a partial surface area of the composite glass pane and a completely prefinished electronic functional module is housed in the cutout, which has a thickness at most equal to the thickness of the polymer film or the film laminate. The electronic functional module has the shape of a flat prism, in particular a flat cuboid, or a flat circular disc and the two main surfaces of the flat prism or the flat circular disc are coated with adhesive for adhesively bonding the electronic functional module between the glass or polycarbonate panes.

WO 2015/097111 A1 describes a method for producing a layered composite, wherein the layered composite comprises a substrate, a cover layer, and an adhesive layer arranged between substrate and cover layer. The adhesive layer at least partially contacts the substrate and the cover layer. The method comprises the following step: pivoting the substrate and the cover layer toward one another so that the distance of the upper substrate edge from the upper cover layer edge decreases and the adhesive is moved in the direction of the upper substrate edge and the upper cover layer edge. This is carried out in such a way that during at least a part of step B), the angle bisector (1000) of the angle α assumes an angle of ≥−45° to ≤45° in relation to the vertical.

The utility model DE 202013105933 U1 discloses a layered composite, comprising a substrate, a cover layer, and a cured adhesive layer arranged between substrate and cover layer, wherein the adhesive layer at least partially contacts the substrate and the cover layer. The substrate comprises a mineral material, the cover layer comprises a glass, an electrical functional unit is arranged between substrate and cover layer, and in the layered composite, the average content of gas bubbles enclosed in the adhesive layer having a maximum dimension of ≥100 μm is less than 100 gas bubbles/m².

The present invention has the object of providing an improved layered composite as can be used, for example, as a multi-pane safety composite glass, and a method for the most bubble-free possible production thereof.

The object is achieved according to the invention by a layered composite according to Claim 1 and a method according to Claim 9. Advantageous refinements are specified in the dependent claims. They can be combined with one another arbitrarily if the contrary does not result clearly from the context.

The layered composite according to the invention has the advantage that significantly higher composite strengths can be implemented without increasing the weight of the composite. The strengths are in particular the combination of the compressive strength and the perforation strength. If equal strengths are required, the composite can be implemented with a lower overall weight.

The thermal capacity of the layered composite can also be significantly increased in comparison to the mentioned typical thermoplastic hot-melt adhesive films. The fire behaviour can also be positively influenced by a lower weight of the polymer layer. Furthermore, the method according to the invention has the advantages that the moisture sensitivity of the composite is reduced in comparison to EVA, PVB, or ionomer intermediate layers. In addition, the production time can be reduced in the case of composite glass from several hours to a few minutes. The energy consumption is also reduced, since the production of the composite can take place at room temperature or slightly elevated temperature and thus no autoclaving process is necessary.

The invention will be explained in more detail by the following drawings, but without being restricted thereto.

In the figures:

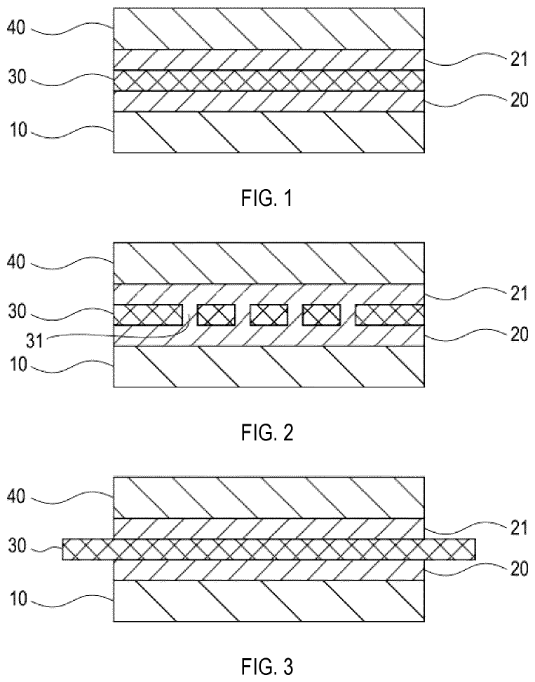

FIG. 1 shows a layered composite according to the invention

FIG. 2 shows a further layered composite according to the invention

FIG. 3 shows a further layered composite according to the invention

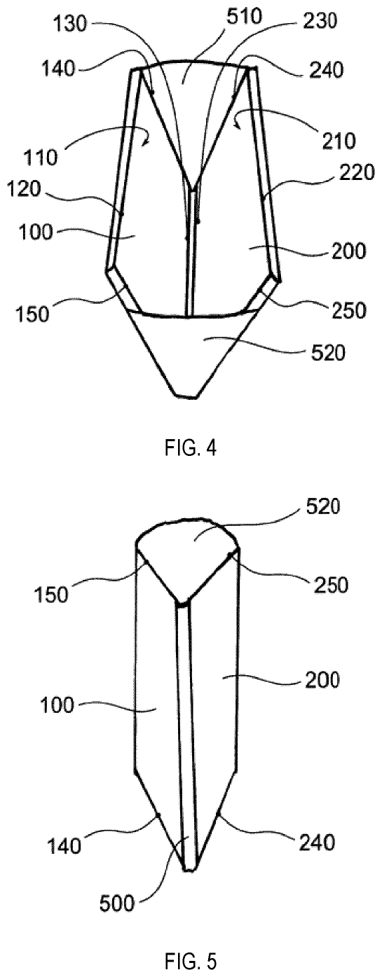

FIGS. 4-6 show arrangements in a method for producing a layered composite according to the invention

FIG. 1 shows a layered composite, comprising a substrate 10, a cover layer 40, and a polymer layer 30 arranged therebetween, wherein the polymer layer is bonded by means of adhesive layers 20, 21 to the substrate 10 and the cover layer 40. It is provided according to the invention that the cover layer 40 has a light transmittance according to DIN EN ISO 410 of ≥50%, the polymer layer 30 has a tensile strength according to DIN EN ISO 527 of ≥30 MPa, and the adhesive layers 20, 21 are layers of a cured, for example multi-component reactive adhesive and/or radiation-curing adhesive.

Examples of suitable materials for the substrate 10 are mineral materials or glass. Suitable mineral materials are, for example, rock, natural stone, concrete, plaster, and the like. “Natural stone” is understood very generally as all stones as are found in nature. Preferred natural stones are granite, marble, quartz, quartz composite, travertine, sandstone, slate, and agate. Examples of suitable glasses are E glass, S glass, M glass, quartz glass, borosilicate glass, crown glass, soda lime glass, float glass, flint glass, and/or lead crystal glass. The glass for the substrate 10 can be coloured or uncoloured. The thickness of the substrate 10 is preferably ≥1 mm to ≤40 mm and more preferably ≥2 mm to ≤20 mm.

Examples of suitable materials for the cover layer 40 are polymethyl (meth)acrylate, polycarbonate, and glass. Examples of suitable glasses are E glass, S glass, M glass, quartz glass, borosilicate glass, crown glass, soda lime glass, float glass, flint glass, and/or lead crystal glass. The glass for the cover layer 40 can be coloured or uncoloured. The thickness of the cover layer 40 is preferably ≥1 mm to ≤40 mm and more preferably ≥2 mm to ≤20 mm.

The cover layer 40 has a light transmittance according to DIN EN ISO 410 of ≥50% and can therefore be characterized as at least partially transparent. The light transmittance is preferably ≥60%, more preferably ≥70%, particularly preferably ≥80%, and very particularly preferably ≥90%. According to one embodiment, the substrate 10 can also have the above-mentioned light transmittances (≥50%, preferably ≥60%, more preferably ≥70%, particularly preferably ≥80%, very particularly preferably ≥90%). According to a further embodiment, the polymer layer 30 can also have the above-mentioned light transmittances. According to a further embodiment, the adhesive layers 20, 21 can also have the above-mentioned light transmittances. According to a further embodiment, the layer composite as a whole has the above-mentioned light transmittances. In particular, the light transmittance of the layered composite can be ≥90%.

The polymer layer 30 can be embodied as continuous or discontinuous. It is preferred for the area of the polymer layer, defined by its outer border, to be equal to or greater than the area of the substrate 10 and/or the cover layer 40. For example, the layered composite can be trimmed at the edges after its production, so that the areas of substrate 10, polymer layer 30, and cover layer 40 are equal.

The polymer layer 30 has a tensile strength according to DIN EN ISO 527 of ≥30 MPa. The tensile strength is preferably ≥40 MPa to ≤300 MPa and more preferably ≥50 MPa to ≤250 MPa. For the purposes of the present invention, it is assumed that the tensile strength of the polymer layer 30 in the layered composite can be equated to the tensile strength of a free layer of the same material. Therefore, for example, the datasheet of a polymer film can be consulted in order to select a polymer layer 30 which is suitable in accordance with the invention. If the tensile strengths of the polymer layer differ in the machine direction and in the transverse direction, the lower of the two values is selected.

The thickness of the polymer layer 30 can be ≥0.05 mm to ≤4 mm, preferably ≥0.10 mm to ≤3 mm, and more preferably ≥0.15 mm to ≤2 mm. The polymer layer 30 can be formed in one part or multiple parts. Multi-part polymer layers can be implemented, inter alia, by laminated film stacks.

The adhesive layer 20 is the adhesive layer which bonds the substrate 10 to the polymer layer 30. The adhesive layer 21 bonds the cover layer 40 to the polymer layer 30. It is preferred for the same adhesive to be present in the adhesive layers 20 and 21. The thickness of an adhesive layer 20 and/or 21 can be ≥1 μm to ≤650 μm (preferably ≥2 μm to ≤400 μm, more preferably ≥3 μm to ≤150 μm, particularly preferably ≥5 μm to ≤50 μm).

The adhesive layers 20, 21 are layers of a cured reactive adhesive and/or radiation-curing adhesive. The adhesives are preferably transparent and in particular are two-component adhesives such as epoxy resins, (meth)acrylate resins, and polyurethane resins as well as radiation-curing adhesives such as (meth)acrylates and urethane (meth)acrylates. Dual cure adhesives are also suitable, in which radiation curing and curing without irradiation take place concurrently or in succession.

In the layered composite according to the invention, the average content of gas bubbles enclosed in the adhesive layers 20, 21 having a maximum dimension of ≥100 μm is preferably less than 100 gas bubbles/m². The gas bubble content can be determined, for example, by means of optical assessment and counting the gas bubbles. Automated methods are also conceivable, which examine the layered composite by means of a camera and software for image processing. The average content of these gas bubbles is preferably less than 10 gas bubbles/m², more preferably less than 1 gas bubble/m². The lower the gas bubble content is, the higher the quality of the layered composite is perceived to be by the end user.

According to a further embodiment, the layered composite can comprise multiple polymer layers 30. For example, the layered composite can have the following structure, wherein the individual layers are mentioned on the basis of their reference signs in FIG. 1 for simplification: 10-[20-30]ₙ-21-40, wherein [20-30]ₙ, means the repetition unit made up of adhesive layer 20 and polymer layer 30 and n means the number of the repetition units. For example, n can assume values of 2, 3, 4, 5, 6, 7, 8, 9, or 10.

According to one embodiment, the cured adhesive of the adhesive layers (20, 21) has an elongation at break according to DIN EN ISO 527 of ≥10%. The elongation at break is preferably ≥10% to ≤600%, more preferably ≥50% to ≤500%, and particularly preferably ≥200% to ≤460%. Without being fixed on a theory, it is assumed that at such elongations at break, an optimum of two opposing effects can be achieved. Adhesive layers which are excessively stretchy are undesired from the aspect of heat resistance and layers which are not stretchy enough cause worse fixing of adhering glass splinters.

According to a further embodiment, the cured adhesive of the adhesive layers 20, 21 has a tensile strength according to DIN EN ISO 1465 of ≥2 MPa. The tensile strength value is preferably ≥4 MPa to ≤50 MPa and more preferably ≥6 MPa to ≤35 MPa.

It is particularly preferred if the cured adhesive of the adhesive layers 20, 21 has the described elongations at break and tensile strengths at the same time.

According to a further embodiment, the polymer layer 30 comprises a polyester polymer, thermoplastic polyurethane polymer, or a polycarbonate polymer. The polymer layer 30 preferably comprises a stretched, particularly preferably a biaxially stretched polyester film. Such polyester films can have softening temperatures of 200° C. or more. In this way, the thermal stability of the layered composite in case of fire is increased, in particular in comparison to EVA and PVB composite glass. Biaxially stretched polyester films can reach tensile strengths of 150 MPa or more. Such high tensile strengths have a favourable effect on the mechanical stability of the layered composites, in particular in situations such as storms, during which debris is thrown through the air.

According to a further embodiment, the polymer layer 30 is formed as a film without recesses, as a film with one or more recesses 31, as a woven fabric, or as a nonwoven fabric. The case that the polymer layer 30 is formed as a film without recesses can be seen in FIG. 1. FIG. 2 shows the case that the polymer layer 30 is formed as a film with recesses 31. An additional continuous adhesive bond is formed between substrate 10 and cover layer 40 by the recesses 31. This can result in increased strengths and special optical effects. In the case that adhesive and polymer layer have the same index of refraction, the recesses become invisible.

The recesses 31 can be arranged regularly or randomly. Examples of cross sections of the recesses 31 are round, oval, square, rectangular, and strip-shaped. The recesses 31 can make up, for example, ≥1% to ≤70% and more preferably ≥5% to ≤50% of the total area of the film which forms the polymer layer 30. Continuous adhesive bonds can also be implemented between substrate 10 and cover layer 40 by the design as a woven fabric or nonwoven fabric.

According to a further embodiment, at least a part of the polymer layer 30 protrudes out of the layered composite. This is shown in FIG. 3. For example, the polymer layer 30 can protrude by ≥0.5 cm to ≤20 cm and more preferably ≥1 cm to ≤10 cm.

The protruding part of the polymer layer 30 can be used for mounting and/or sealing the layered composite in a frame, for example in a window frame. This has the advantage that in the case of a window the compressive strength is increased, for example in the case of extreme wind loads.

According to a further embodiment, the polymer layer 30 is not able to be post cross-linked or is not post cross-linked. Therefore, in particular ionomer films are excluded. The post cross-linking relates in particular to thermal post cross-linking, although this also includes photochemical post cross-linking.

According to a further embodiment, the layered composite has at least one of the following properties:
substrate 10 and cover layer 40 are, independently of one another, glass layers of a thickness of ≥1 mm to ≤40 mm;
the polymer layer 30 has a thickness of ≥0.05 mm to ≤4 mm (preferably ≥0.1 mm to ≤2 mm, more preferably ≥0.15 mm to ≤1 mm);
the sum of the thicknesses of polymer layer 30 and adhesive layers (20, 21) is ≥0.06 mm to ≤5.3 mm (preferably ≥0.1 mm to ≤2.1 mm); and
the thickness of an adhesive layer (20, 21) is ≥1 μm to ≤650 μm (preferably ≥2 μm to ≤400 μm, more preferably ≥3 μm to ≤150 μm, particularly preferably ≥5 μm to ≤50 μm).

The method according to the invention will be explained with reference to FIGS. 4 to 6. The method for producing a layered composite according to the invention comprises:
A) providing an arrangement, which comprises a substrate 100 and a cover layer 200, wherein
   the substrate 100 comprises a first substrate side 110 having an upper substrate edge 120 viewed in the vertical direction, a lower substrate edge 130 viewed in the vertical direction, a first substrate lateral edge 140, and a second substrate lateral edge 150 opposite to the first substrate lateral edge;
   the cover layer 200 comprises a first cover layer side 210 having an upper cover layer edge 220 viewed in the vertical direction, a lower cover layer edge 230 viewed in the vertical direction, a first cover layer lateral edge 240, and a second cover layer lateral edge 250 opposite to the first cover layer lateral edge;
   the first substrate side 110 and the first cover layer side 210 in the arrangement face toward one another at an angle α and an angle bisector 1000 of the angle α is formed;
   the upper substrate edge 120 and the upper cover layer edge 220 are opposite to one another in the arrangement;
   the lower substrate edge 130 and the lower cover layer edge 230 are opposite to one another in the arrangement;
   the first substrate lateral edge 140 and the first cover layer lateral edge 240 are opposite to one another in the arrangement;
   the second substrate lateral edge 150 and the second cover layer lateral edge 250 are opposite to one another in the arrangement;
   in the arrangement, the distance of the upper substrate edge 120 to the upper cover layer edge 220 is greater than the distance of the lower substrate edge 130 to the lower cover layer edge 230;
   in the arrangement, a first seal 500 is provided between the lower substrate edge 130 and the lower cover layer edge 230, which prevents the escape of fluids between lower substrate edge 130 and lower cover layer edge 230;
   in the arrangement, a second seal 510 is provided between the first substrate lateral edge 140 and the first cover layer lateral edge 240, which prevents the escape of fluids between first substrate lateral edge 140 and first cover layer lateral edge 240;
   in the arrangement, a third seal 520 is provided between the second substrate lateral edge 150 and the second cover layer lateral edge 250, which prevents the escape of fluids between second substrate lateral edge 150 and second cover layer lateral edge 250;
   so that the arrangement forms a container open on one side for receiving fluids and furthermore an adhesive 310 capable of curing is present in this container;
B) pivoting the substrate 100 and the cover layer 200 toward one another so that the distance of the upper substrate edge 120 to the upper cover layer edge 220 decreases and the adhesive 310 is moved in the direction of the upper substrate edge 120 and the upper cover layer edge 220;
C) causing the adhesive 310 to cure.

In the arrangement according to A), furthermore a polymer layer 400 having a tensile strength according to DIN EN ISO 527 of ≥30 MPa is located between substrate 100 and cover layer 200. The tensile strength is preferably ≥40 MPa to ≤300 MPa and more preferably ≥50 MPa to ≤250 MPa.

Details on materials and dimensions of substrate, cover layer, adhesive, and polymer layer were already mentioned in conjunction with the layered composite according to the invention and will not be repeated at this point. These specifications apply equally to the method according to the invention.

According to one embodiment of the method, at least during steps A), B), and C), the temperature of the polymer layer (400) is ≤50° C. The temperature is preferably ≤40° C. and more preferably ≤30° C. In this way, it is expressed that an autoclaving process, as would be necessary for the thermal cross-linking of EVA or ionomer films, does not have to be part of the method.

According to a further embodiment of the method, heating of the layered composite to a temperature of ≥100° C. is not carried out after step C). Preferably, heating is not performed to ≤80° C. and particularly preferably heating is not performed to ≤60° C. In this way, it is likewise expressed that an autoclaving process, as would be necessary for the thermal cross-linking of EVA or ionomer films, does not have to be part of the method.

According to a further embodiment of the method, at least at the beginning of the pivoting in step B), the adhesive 310 has a viscosity at 20° C. according to DIN EN 12092 of ≤50 000 mPas. The viscosity is preferably ≥10 mPas to ≤20 000 mPas and more preferably ≥50 mPas to ≤10 000 mPas.

According to a further embodiment of the method, the polymer layer 400 comprises a polyester polymer, thermoplastic polyurethane polymer, or a polycarbonate polymer.

According to a further embodiment of the method, the polymer layer 400 is formed as a film without recesses, as a film with one or more recesses 31 (see FIG. 2), as a woven fabric, or as a nonwoven fabric.

According to a further embodiment of the method, the polymer layer 400 is not able to be post cross-linked or is not post cross-linked. Therefore, in particular ionomer films are excluded. The post cross-linking relates in particular to thermal post cross-linking, although this also includes photochemical post cross-linking.

FIG. 4 shows an arrangement for use in the method according to the invention, on the basis of which several spatial relationships and geometric definitions are to be explained. However, no adhesive present in the arrangement and no polymer layer are depicted in FIG. 4 for better clarity.

As already described, an arrangement of a substrate and a cover layer is provided in the method according to the invention. The way to build up this arrangement, for example the individual steps and their sequence, is not defined here.

In the arrangement as shown in FIG. 4, a substrate 100 and a cover layer 200 are present. The substrate has a first substrate side 110. This first substrate side 110 will be adhesively bonded in the further course of things with the corresponding first cover layer side 210 of the cover layer 200.

Various edges are defined on the participating substrate or cover layer sides. The first substrate side 110 has an upper substrate edge 120 viewed in the vertical direction (counter to gravity) and a lower substrate edge 130 opposite thereto viewed in the vertical direction. In the case shown in FIG. 4, these edges extend horizontally. The substrate lateral edges 140 and 150, which extend vertically here, are located adjacent to the upper and lower substrate edges 120, 130.

The first cover layer side 210 also has an upper cover layer edge 220, a lower cover layer edge 230, and two cover layer lateral edges 240, 250, which are opposite to one another. The first substrate side 110 and the first cover layer side 210 face toward one another, so that substrate 200 and cover layer 210 represent an approximately “V”-shaped formation. The upper substrate edge 120 and the upper cover layer edge 220 as well as the lower substrate edge 130 and the lower cover layer edge 230 are opposite to one another. Likewise, the first substrate lateral edge 140 and the first cover layer lateral edge 240 and the second substrate lateral edge 150 and the second cover layer lateral edge 250 are opposite to one another. In accordance with the description of the formation as “V-shaped”, the distance of the upper substrate edge 120 from the upper cover layer edge 220 is greater than the distance of the lower substrate edge 130 from the lower cover layer edge 230.

The “V-shaped” formation is made into a container open on top or, speaking visually, into a trough by the use of sealants. These sealants seal the gaps between the opposing edges of substrate 100 and cover layer 200.

A second seal 510 seals here between first substrate lateral edge 140 and first cover layer lateral edge 240 and a third seal 520 seals between second substrate lateral edge 150 and second cover layer lateral edge. The fact that the arrangement in the method according to the invention is embodied as open on one side and in particular as “open on top” means that displaced adhesive has enough space to leave the gap formed between substrate 100 and cover layer 200. The fact of being open on one side also includes that the arrangement is covered all around, but the adhesive can escape as stated.

FIG. 5 shows the arrangement from FIG. 4 in a view diagonally from below. The substrate 100 and the cover layer 200, the lateral edges 140, 150, 240, and 250 and one of the lateral seals 520 can again be seen. The first seal 500, which prevents the escape of fluids (in particular adhesive) between the lower edge of the substrate and the cover layer, can now also be seen. The first seal 500, second seal 510, and third seal 520 are designed by overlapping, for example, in such a way that overall the arrangement represents a container open on top, which can receive an adhesive. However, they can also be combined and can be present as a whole as one seal piece, for example.

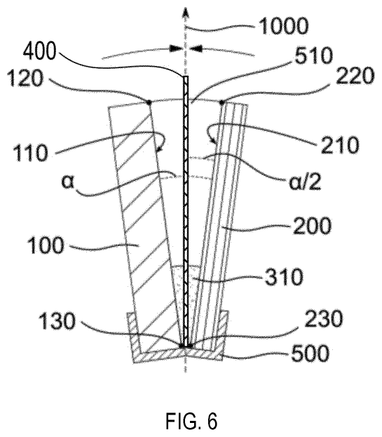

FIG. 6 shows a cross-sectional view of the arrangement shown in FIG. 4 and FIG. 5 wherein now an adhesive 310 capable of curing and a polymer layer 400 are furthermore present in the container open on top that is formed. The adhesive therefore already at least partially contacts the first substrate side 110 and the first cover layer side 210. The polymer layer 400 can be introduced before adhesive is poured into the arrangement according to FIG. 4 and FIG. 5. It is also possible that the adhesive is poured in first and then the polymer layer is introduced into the arrangement.

The adhesive is prevented from escaping from the container by the seals provided. Due to the cross-sectional view, the seal 520 from FIGS. 4 and 5 is not shown in FIG. 6. It is also not important for the method according to the invention whether the adhesive 310 is poured into the fully constructed “trough” made up of substrate 100, cover layer 200, and seals 500, 510, 520 or whether it is, for example, already present on substrate and/or cover layer and then the “trough” is constructed. An angle α is formed between the first substrate side 110 and the first cover layer side 210. An angle bisector 1000 can be constructed accordingly.

In the method according to the invention, the substrate 100 and the cover layer are pivoted toward one another. In this case, at least the distance of the upper substrate edge 120 from the upper cover layer edge 220 increases. Visually speaking, this can be compared to folding closed a book. The “spine of the book” is formed in this case by the lower edges 130, 230 and the lower first seal 500. The pivoting is symbolized by the two curved arrows in FIG. 6. Pivoting the substrate 100 and the cover layer 200 toward one another has the result that the adhesive arranged between them is pressed farther and farther along the gaps between substrate 100, polymer layer 400, and cover layer 200. It is therefore also moved further and further in the direction of the upper substrate edge 120 and the upper cover layer edge 120.

It can be provided in the method according to the invention that during at least a part of step B (pivoting), the angle bisector 1000 of the angle α assumes an angle of ≥−45° to ≤45° in relation to the vertical. In this way, the opening of the arrangement always faces upward, so that air bubbles enclosed in the adhesive can also rise upward and can leave the gap between substrate 100 and cover layer 200. The angle bisector 1000 of the angle α preferably assumes an angle of ≥−30° to ≤30°, more preferably ≥−15° to ≤15° in relation to the vertical in this case. This can then be referred to as an “upright adhesive bond” of the substrate 100 and the cover layer 200.

In FIG. 6, the angle bisector 1000 has an angle of 0° in relation to the vertical. Negative angles in this case mean that the angle bisector 1000 is inclined to the left; positive angles symbolize an inclination in the other direction. The sign of the angle of inclination is insofar also dependent on the observation viewpoint. The lower substrate edge 130 and the lower cover layer edge 230 do not necessarily have to touch. Because the first seal 500 is present, they can also be arranged spaced apart from one another. Their spacing can be selected in consideration of the desired thickness of the adhesive layer in the finished layered composite.

The adhesive 310 can be caused to cure, for example, by UV exposure or also by having a 2-component adhesive react.

### EXAMPLES

The present invention will be described further by the following examples, but without being restricted thereto.

The tensile strengths (DIN EN ISO 527) of the films used were:

| | Longitudinal | Transverse |
|---|---|---|
| | direction | direction |
| | (MD) [MPa] | (TD) [MPa] |
| Ionomer film (not thermally | Approximately 5 | Approximately 5 |
| post cross-linked) | | |
| PVB film | 20 | |
| Soft PVC film | 25 | |
| Polyurethane film | 42 | 35 |
| Polyester film (biaxially stretched) | 190 | 220 |
| Polycarbonate film | 55 | |

The adhesives used are listed hereinafter. The specified elongations at break (DIN EN ISO 527) relate to the cured adhesive.

| | | Elongation at |
|---|---|---|
| | Description | break [%] |
| UV adhesive 1 | UV-curing 1-component casting resin based on acrylic resin | 380 |
| UV adhesive 2 | UV-curing 1-component urethane acrylate resin, made flame | 450 |
| | retardant | |
| UV adhesive 3 | UV-curing 1-component urethane acrylate resin; main components: | 300 |
| | methyl methacrylate and acrylate-terminated aliphatic polyurethane | |
| UV adhesive 4 | UV-curing 1-component resin based on modified acrylates | 4 |

All tests were carried out using round, clear float glass discs (2 mm thickness/10 cm diameter) and/or films (different thicknesses, 10 cm diameter). The adhesive bonds on glass discs were produced using the UV-curing adhesive (layer thicknesses of the adhesive approximately 0.005 mm). Curing was performed for 20 minutes using a 2000 W Hnle UVA lamp (UVA spot 200) at a distance of 75 cm. This corresponded to a UV irradiance of 50 mW/cm².

To determine the compressive strength and the perforation strength, the samples were clamped in a steel cylinder having 10 cm external diameter and 8.4 mm internal diameter. The samples were pressed in using a spindle press having rounded Teflon head (2 cm diameter) and the weight exerted by the Teflon head on the samples was measured. The lowering speed of the Teflon head was 15 cm/min. The value for the compressive strength was read off when the sample body as a whole broke or splintered. The value for the perforation strength was read off as soon as the stamp penetrated the sample body.

It was observed that for samples up to approximately 1 mm thickness, the perforation strength behaved substantially linearly as a function of the layer thickness in the course of the test method. This enabled the conversion of the perforation strength of films and adhesive layers to a unit thickness (here: 0.25 mm), in order to make the results more comparable.

1. Results of the Tests on Glass Discs without Interposed Films

| | Compressive | Perforation |
|---|---|---|
| | strength [kg] | strength [kg] |
| One disc | 70 | n.d. |
| Two discs, not adhesively bonded | 70 | n.d. |
| Two discs, bonded using UV adhesive 3 | 140 | n.d. |
| Two discs, bonded using UV adhesive 4 | 140 | n.d. |

In the experiment using the glass discs bonded using UV adhesive 4, splintering of the glass discs into many individual parts was observed. Such free individual parts only occurred to a very minor extent in the parallel experiment using the UV adhesive 3.

### 2. Results of the Tests on Cured Adhesive Films and on Polymer Films (Each Standardized to a Thickness of 0.25 mm)

| | Compressive | Perforation |
|---|---|---|
| | strength [kg] | strength [kg] |
| UV adhesive 1 | — | 20 |
| UV adhesive 2 | — | 10 |
| UV adhesive 3 | — | 28 |
| UV adhesive 4 | Approximately 5 | n.d. |
| | (splintered) | |
| EVA film (not thermally | — | 13 |
| post cross-linked) | | |
| Ionomer film (not thermally | — | 42 |
| post cross-linked) | | |
| PVB film | — | 93 |
| Soft PVC film | — | 35 |
| Polyurethane film | — | 40 |
| Polyester film (biaxially stretched) | — | 260 |
| Polycarbonate film | — | 112 |

3. Results of the tests on layered composites. The layered composites had the following Structure: Glass/Cured UV Adhesive 3/Polymer Film/Cured UV Adhesive 3/Glass.

| | Compressive | Perforation |
|---|---|---|
| Polymer film | strength [kg] | strength [kg] |
| Ionomer film (not thermally | 130 | 130 |
| post cross-linked); | | |
| comparative example | | |
| Polyester film (biaxially stretched) | 240 | 240 |
| Polycarbonate film | 180 | 180 |
| PVB film; comparative example | 135 | 135 |

### 4. Results of the Test on a Layered Composite Having the Following Structure: Glass/Cured UV Adhesive 4/Biaxially Stretched Polyester Film/Cured UV Adhesive 4/Glass

The experimental setup corresponded to the compressive strength and perforation strength tests as mentioned above. In the experiment using the layered composite adhesively bonded using UV adhesive 4, splintering of the glass discs into many free individual parts was observed. Such free individual parts only occurred to a very minor extent in the parallel experiment using the UV adhesive 3.

1. Layered composite, comprising a substrate, a cover layer, and a polymer layer arranged therebetween, wherein the polymer layer is bonded by means of adhesive layers with the substrate and the cover layer,
characterized in that
the cover layer has a light transmittance according to DIN EN ISO 410 of ≥50%,
the polymer layer has a tensile strength according to DIN EN ISO 527 of ≥30 MPa, and
the adhesive layers are layers of a cured reactive adhesive and/or radiation-curing adhesive.

2. Layered composite according to claim 1, wherein the cured adhesive of the adhesive layers has an elongation at break according to DIN EN ISO 527 of ≥10%.

3. Layered composite according to claim 1, wherein the cured adhesive of the adhesive layers has a tensile strength according to DIN EN ISO 1465 of ≥2 MPa.

4. Layered composite according to claim 1, wherein the polymer layer comprises a polyester polymer, a thermoplastic polyurethane polymer, or a polycarbonate polymer.

5. Layered composite according to claim 1, wherein the polymer layer is formed as a film without recesses, as a film with one or more recesses, as a woven fabric, or as a nonwoven fabric.

6. Layered composite according to claim 1, wherein at least a part of the polymer layer protrudes out of the layered composite.

7. Layered composite according to claim 1, wherein the polymer layer is not able to be post cross-linked or is not post cross-linked.

8. Layered composite according to claim 1 having at least one of the following properties:
substrate and cover layer are, independently of one another, glass layers of a thickness of ≥1 mm to ≤40 mm;
the polymer layer has a thickness of ≥0.05 mm to ≤4 mm;
the sum of the thicknesses of polymer layer and adhesive layers is ≥0.06 mm to ≤5.3 mm; and
the thickness of an adhesive layer is ≥1 μm to ≤650 μm.

9. Method for producing a layered composite according to claim 1, comprising:
A) providing an arrangement, which comprises a substrate and a cover layer, wherein
the substrate comprises a first substrate side having an upper substrate edge viewed in the vertical direction, a lower substrate edge viewed in the vertical direction, a first substrate lateral edge, and a second substrate lateral edge opposite to the first substrate lateral edge;
the cover layer comprises a first cover layer side having an upper cover layer edge viewed in the vertical direction, a lower cover layer edge viewed in the vertical direction, a first cover layer lateral edge, and a second cover layer lateral edge opposite to the first cover layer lateral edge;
the first substrate side and the first cover layer side in the arrangement face toward one another at an angle α and an angle bisector of the angle α is formed;
the upper substrate edge and the upper cover layer edge are opposite to one another in the arrangement;
the lower substrate edge and the lower cover layer edge are opposite to one another in the arrangement;
the first substrate lateral edge and the first cover layer lateral edge are opposite to one another in the arrangement;
the second substrate lateral edge and the second cover layer lateral edge are opposite to one another in the arrangement;
in the arrangement, the distance of the upper substrate edge to the upper cover layer edge is greater than the distance of the lower substrate edge to the lower cover layer edge;
in the arrangement, a first seal is provided between the lower substrate edge and the lower cover layer edge, which prevents the escape of fluids between lower substrate edge and lower cover layer edge;
in the arrangement, a second seal is provided between the first substrate lateral edge and the first cover layer lateral edge, which prevents the escape of fluids between first substrate lateral edge and first cover layer lateral edge;
in the arrangement, a third seal is provided between the second substrate lateral edge and the second cover layer lateral edge, which prevents the escape of fluids between second substrate lateral edge and second cover layer lateral edge;
so that the arrangement forms a container open on one side for receiving fluids and furthermore an adhesive capable of curing is present in this container;
B) pivoting the substrate and the cover layer toward one another, so that the distance of the upper substrate edge from the upper cover layer edge decreases and the adhesive is moved in the direction of the upper substrate edge and the upper cover layer edge;
C) causing the adhesive to cure;
characterized in that
in the arrangement according to A), furthermore a polymer layer having a tensile strength according to DIN EN ISO 527 of ≥30 MPa is present between substrate and cover layer.

10. Method according to claim 9, wherein at least during steps A), B), and C), the temperature of the polymer layer (400) is ≤50° C.

11. Method according to claim 9, wherein after step C), heating of the layered composite to a temperature of ≥100° C. is not carried out.

12. Method according to claim 9, wherein at least at the beginning of the pivoting in step B), the adhesive has a viscosity at 20° C. according to DIN EN 12092 of ≤50 000 mPas.

13. Method according to claim 9, wherein the polymer layer comprises a polyester polymer, a thermoplastic polyurethane polymer, or a polycarbonate polymer.

14. Method according to claim 9, wherein the polymer layer is formed as a film without recesses, as a film with one or more recesses, as a woven fabric, or as a nonwoven fabric.

15. Method according to claim 9, wherein the polymer layer is not able to be post cross-linked or is not post cross-linked.
